(19) United States
(12) Patent Application Publication
(10) Pub. No.: US 2025/0368050 A1
(43) Pub. Date: Dec. 4, 2025

(54) DEVICE AND METHOD FOR ACQUIRING ACTUAL DECELERATION, DETERIORATION DISCRIMINATION, AND BRAKE CONTROL

(71) Applicant: Mitsubishi Electric Corporation, Chiyoda-ku, Tokyo (JP)

(72) Inventors: Etsuji MATSUYAMA, Tokyo (JP); Shumpei ONODERA, Tokyo (JP); Tsutomu NISHIOKA, Tokyo (JP)

(73) Assignee: Mitsubishi Electric Corporation, Chiyoda-ku, Tokyo (JP)

(21) Appl. No.: 18/875,310

(22) PCT Filed: Jun. 22, 2022
(86) PCT No.: PCT/JP2022/024878

§ 371 Date: Dec. 16, 2024

(51) Int. Cl. B60L 3/12; B60L 7/26; B60T 17/22; B61C 3/00; B61L 25/02

(52) U.S. Cl. CPC B60L 3/12; B60L 7/26; B60T 17/228; B61C 3/00; B61L 25/021; B60L 2200/26; B60L 2240/12; B60L 2240/16; B60L 2240/642

(57) ABSTRACT

An actual deceleration acquiring device includes a speed acquirer and a determiner. The speed acquirer acquires a speed of a railway vehicle for a subject period while the railway vehicle is being decelerated by not an electric braking force but a mechanical braking force alone among the mechanical braking force and the electric braking force. The railway vehicle is configured to be decelerated by at least either of the electric braking force and the mechanical braking force. The determiner determines, based on a variation in the speed acquired by the speed acquirer, an actual deceleration of the railway vehicle in the subject period.

### TECHNICAL FIELD

The present disclosure relates to an actual deceleration acquiring device, a deterioration evaluating device, a brake control apparatus, a method of acquiring an actual deceleration, a method of evaluating deterioration, and a method for brake control.

### BACKGROUND ART

Railway vehicles are accelerated by driving forces received from motors rotating in response to electric power fed from a power source. Some of the railway vehicles are decelerated by a mechanical braking force generated by mechanical brake devices and an electric braking force resulting from consumption of electric power output from motors serving as electric generators. Such a railway vehicle is provided with a monitoring device in some cases. The monitoring device monitors an actual deceleration of the railway vehicle, in order to make the actual deceleration of the railway vehicle closer to the target deceleration indicated by a braking command, and to cause the railway vehicle to stop at a desired position. An example of this type of monitoring device is disclosed in Patent Literature 1.

The monitoring device disclosed in Patent Literature 1 calculates a deceleration of a railway vehicle from automatic train control (ATC) data, and evaluates the existence of an abnormality in vehicle bodies on the basis of the calculated deceleration.

### CITATION LIST

### Patent Literature

Patent Literature 1: Unexamined Japanese Patent Application Publication No. 2006-117190

### SUMMARY OF INVENTION

### Technical Problem

The mechanical braking force generated by mechanical brake devices has a larger variation than the electric braking force. The mechanical braking force may vary due to deterioration of components of the mechanical brake devices with age, for example. Such a variation in the mechanical braking force may cause the actual deceleration of the railway vehicle to be deviated from the target deceleration. For suppression of the deviation of the actual deceleration from the target deceleration, a preferable solution is to evaluate a level of deterioration of the mechanical brake devices and control the mechanical brake devices in accordance with the result of evaluation. The evaluation of a level of deterioration of the mechanical brake devices needs an actual deceleration of the railway vehicle caused by the mechanical braking force alone. The actual deceleration calculated by the monitoring device disclosed in Patent Literature 1 is, however, an actual deceleration caused by the mechanical braking force and the electric braking force. The actual deceleration of the railway vehicle caused by the mechanical braking force alone cannot be readily acquired while the railway vehicle is being decelerated by the mechanical braking force and the electric braking force.

An objective of the present disclosure, which has been accomplished in view of the above situations, is to provide an actual deceleration acquiring device, a deterioration evaluating device, a brake control apparatus, a method of acquiring an actual deceleration, a method of evaluating deterioration, and a method for brake control that can acquire an actual deceleration of the railway vehicle caused by the mechanical braking force.

### Solution to Problem

In order to achieve the above objective, an actual deceleration acquiring device according to the present disclosure includes a speed acquirer and a determiner. The speed acquirer acquires, for a subject period, a speed of a railway vehicle that is accelerated by a driving force received from a motor rotating in response to fed electric power and decelerated by at least either of a mechanical braking force or an electric braking force, while the railway vehicle is being decelerated by not the electric braking force but the mechanical braking force alone among the mechanical braking force and the electric braking force. The mechanical braking force is generated by a mechanical brake device. The electric braking force results from consumption of electric power generated by the motor serving as an electric generator. The determiner determines, based on a variation in the speed acquired by the speed acquirer, an actual deceleration of the railway vehicle in the subject period.

### Advantageous Effects of Invention

The actual deceleration acquiring device according to the present disclosure acquires a speed of the railway vehicle for the subject period while the railway vehicle is being decelerated by not an electric braking force but a mechanical braking force alone among the mechanical braking force and the electric braking force, and determines an actual deceleration of the railway vehicle based on the acquired speed. The actual deceleration acquiring device can thus acquire an actual deceleration of the railway vehicle caused by the mechanical braking force.

### BRIEF DESCRIPTION OF DRAWINGS

FIG. 1 is a block diagram illustrating a power conversion apparatus according to Embodiment 1;

FIG. 2 is a block diagram illustrating a brake control apparatus according to Embodiment 1;

FIG. 3 is a block diagram illustrating a deterioration evaluating device according to Embodiment 1;

FIG. 4 illustrates hardware components of the brake control apparatus according to Embodiment 1;

FIG. 5 is a flowchart illustrating an example of an actual deceleration acquiring process executed by an actual deceleration acquiring device according to Embodiment 1;

FIG. 6 illustrates an exemplary variation in speed of a railway vehicle in Embodiment 1;

FIG. 7 is a flowchart illustrating an example of a deterioration evaluating process executed by the deterioration evaluating device according to Embodiment 1;

FIG. 8 is a flowchart illustrating an example of a brake control process executed by the brake control apparatus according to Embodiment 1;

FIG. 9 is a timing chart illustrating operations of the brake control apparatus according to Embodiment 1;

FIG. 10 is a block diagram illustrating a deterioration evaluating device according to Embodiment 2;

FIG. 11 is a block diagram illustrating a brake control apparatus according to Embodiment 2;

FIG. 12 is a flowchart illustrating an example of an actual deceleration acquiring process executed by an actual deceleration acquiring device according to Embodiment 2;

FIG. 13 is a flowchart illustrating an example of a brake control process executed by the brake control apparatus according to Embodiment 2;

FIG. 14 is a timing chart illustrating operations of the brake control apparatus according to Embodiment 2;

FIG. 15 is a flowchart illustrating an example of a deterioration evaluating process executed by a deterioration evaluating device according to Embodiment 3;

FIG. 16 is a flowchart illustrating another example of the deterioration evaluating process executed by the deterioration evaluating device according to the embodiments;

FIG. 17 illustrates an exemplary variation in speed of the railway vehicle in the embodiments; and

FIG. 18 illustrates a modification of the hardware components of the brake control apparatus according to the embodiments.

### DESCRIPTION OF EMBODIMENTS

An actual deceleration acquiring device, a deterioration evaluating device, a brake control apparatus, a method of acquiring an actual deceleration, a method of evaluating deterioration, and a method for brake control according to some embodiments are described in detail below with reference to the accompanying drawings. In the drawings, the components identical or corresponding to each other are provided with the same reference symbol.

### Embodiment 1

Some railway vehicles each including one or more coaches are accelerated by a driving force received from motors, and decelerated by at least either of a mechanical braking force generated by mechanical brake devices and an electric braking force resulting from consumption of electric power generated by the motors serving as electric generators.

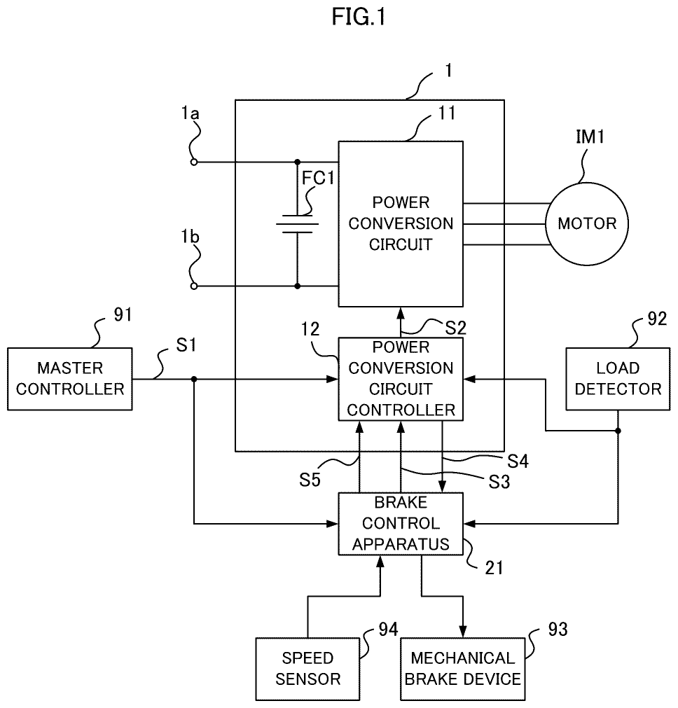

A motor coach of a railway vehicle is provided with a power conversion apparatus 1 and motors IM1 fed with electric power from the power conversion apparatus 1, which are illustrated in FIG. 1. Although FIG. 1 illustrates a single motor IM1 in order to simplify the figure, the power conversion apparatus 1 feeds electric power to multiple motors IM1, for example, four motors IM1 installed in the same coach. A typical example of the motors IM1 is a three-phase induction motor that generates a propulsion force of the railway vehicle. Each of the motors IM1 serves as an electric generator and feeds AC power to the power conversion apparatus 1 during a braking operation of the railway vehicle.

The power conversion apparatus 1 is installed in the railway vehicle of a DC feeding system. The power conversion apparatus 1 converts fed DC power into AC power appropriate for the motors IM1 and feeds the converted AC power to the motors IM1. The power conversion apparatus 1 operates, for example, in accordance with an operation command S1 acquired from a master controller 91, which is installed in a cab.

The operation command S1 indicates a command corresponding to a manipulation of an operator on the master controller 91. Specifically, the operation command S1 contains any of a power running command for instructing the railway vehicle to accelerate, a braking command for instructing the railway vehicle to decelerate, and a coasting command for instructing the railway vehicle to coast. The coasting command indicates a condition in which neither of the power running command nor the braking command is input.

When the operation command S1 contains a power running command, the power conversion apparatus 1 feeds electric power to the motors IM1 in accordance with the power running command, thereby generating a propulsion force of the railway vehicle and allowing the railway vehicle to run.

Each coach of the railway vehicle is provided with a brake control apparatus 21. The brake control apparatus 21 installed in the motor coach controls the power conversion apparatus 1, in accordance with the braking command contained in the operation command S1. The power conversion apparatus 1 thus converts AC power fed from the motors IM1 into DC power and thus outputs the DC power. The DC power output from the power conversion apparatus 1 is fed to other railway vehicles during power running in the vicinity of the railway vehicle provided with the power conversion apparatus 1, and consumed by these railway vehicles, resulting in generation of an electric braking force of the railway vehicle.

The brake control apparatus 21 controls mechanical brake devices 93, in accordance with the braking command contained in the operation command S1 and the weight of the coach detected by a load detector 92, resulting in generation of a mechanical braking force. The railway vehicle is decelerated by at least either of the electric braking force and the mechanical braking force.

The brake control apparatus 21 acquires an actual deceleration of the railway vehicle caused by the mechanical braking force, evaluates a level of deterioration of the mechanical brake devices 93 in accordance with the actual deceleration, and executes brake control in accordance with the level of deterioration of the mechanical brake devices 93. Examples of deterioration of the mechanical brake devices 93 include, not only deterioration of components included in the mechanical brake devices 93, for example, deterioration of friction members, and a reduction in mechanical efficiency of brake cylinders, but also deterioration of components around the mechanical brake devices 93, for example, deterioration of electropneumatic valves for feeding air to the mechanical brake devices 93. In Embodiment 1, the brake control apparatus 21 evaluates whether any deterioration occurs in the mechanical brake devices 93, as the evaluation of a level of deterioration of the mechanical brake devices 93.

Although FIG. 1 illustrates only a single mechanical brake device 93 in order to simplify the figure, the mechanical brake device 93 is provided to each wheel. For example, each coach is provided with eight mechanical brake devices 93 corresponding to mutually different wheels. Each of the mechanical brake devices 93 includes a brake shoe having a friction member that comes into contact with the wheel and generates a mechanical braking force, and a brake cylinder provided to the brake shoe and fed with air supplied from a non-illustrated air reservoir and compressed by the brake control apparatus 21, for example.

Although FIG. 1 illustrates only a single speed sensor 94 in order to simplify the figure, the speed sensor 94 is provided to each axle. For example, each coach is provided with four speed sensors 94 corresponding to mutually different axles.

The power conversion apparatus 1 includes a terminal 1a connected to a power source, a grounded terminal 1b, and a power conversion circuit 11 that converts DC power fed from the power source into electric power to be fed to the motors IM1, and feeds the converted electric power to the motors IM1. The power conversion apparatus 1 further includes a filter capacitor FC1 connected between the primary terminals of the power conversion circuit 11, and a power conversion circuit controller 12 that controls the power conversion circuit 11.

The terminal 1a is electrically connected via components, such as reactor and contactor, which are not illustrated, to the power source, more specifically, a current collector that acquires electric power fed from a substation via a power supply line. Examples of the current collector include a pantograph to acquire electric power via an overhead wire, which is an example of the power supply line, and a contact shoe to acquire electric power via a third rail, which is another example of the power supply line. The terminal 1b is grounded via components, such as ground ring, ground brush, and wheel, which are not illustrated.

The power conversion circuit 11 includes an inverter that outputs AC power with variable effective voltage and variable frequency, for example. The power conversion circuit 11 has multiple switching elements, each of which executes switching operations under the control of the power conversion circuit controller 12. Each of the switching elements is made of an insulated gate bipolar transistor (IGBT), or a switching element including a wide bandgap semiconductor made of silicon carbide (SiC), gallium nitride (GaN), or diamond.

The switching elements are controlled by the power conversion circuit controller 12, and allow the power conversion circuit 11 to convert DC power fed from the power source via the filter capacitor FC1 into three-phase AC power and feed the three-phase AC power to the motors IM1, or to convert three-phase AC power fed from the motors IM1 into DC power and charge the filter capacitor FC1 with the DC power.

One end of the filter capacitor FC1 is connected to the connecting point between the terminal 1a and one of the primary terminals of the power conversion circuit 11. The other end of the filter capacitor FC1 is connected to the connecting point between the terminal 1b and the other of the primary terminals of the power conversion circuit 11. The filter capacitor FC1 and the reactor, which is not illustrated and connected to the terminal 1a, serve as an inductor-capacitor (LC) filter to reduce harmonic components generated by switching operations of the switching elements of the power conversion circuit 11.

The power conversion circuit controller 12 acquires the operation command S1 from the master controller 91. The power conversion circuit controller 12 generates power conversion control signals S2 for controlling the individual switching elements of the power conversion circuit 11 in accordance with the operation command S1, and outputs the generated power conversion control signals S2. A typical example of the power conversion control signals S2 is a pulse width modulation (PWM) signal.

When the operation command S1 contains a power running command, the power conversion circuit controller 12 determines a target torque, which is a target value of torque of the motors IM1, in accordance with a target acceleration, which is a target value of acceleration of the railway vehicle indicated by the power running command and in accordance with the weight of the coach detected by the load detector 92. The power conversion circuit controller 12 then outputs the power conversion control signals S2 corresponding to the target torque, to the power conversion circuit 11.

When the operation command S1 contains a braking command, the power conversion circuit controller 12 acquires a regeneration pattern S3 from the brake control apparatus 21, and outputs power conversion control signals S2 corresponding to a target electric braking force, which is a target value of electric braking force indicated by the regeneration pattern S3, to the power conversion circuit 11. The power conversion circuit controller 12 outputs a regeneration feedback S4 indicating an actual electric braking force to the brake control apparatus 21.

The power conversion circuit controller 12, when receiving a deactivation signal S5 for instructing deactivation of the power conversion circuit 11 from the brake control apparatus 21, outputs power conversion control signals S2 for turning off the switching elements of the power conversion circuit 11, to the power conversion circuit 11.

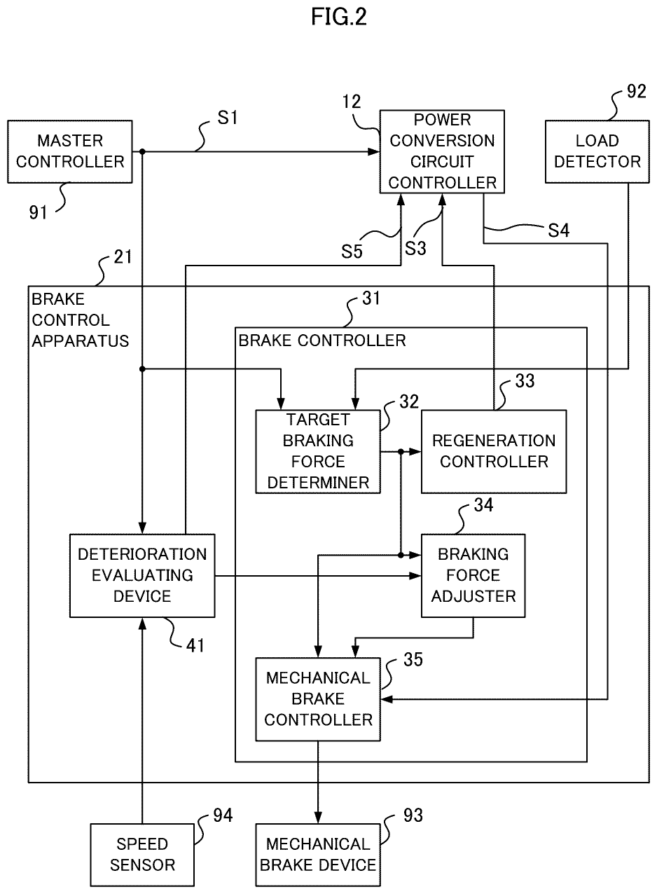

As illustrated in FIG. 2, the brake control apparatus 21 includes a brake controller 31 that controls the power conversion circuit controller 12 and the mechanical brake devices 93, and a deterioration evaluating device 41 that evaluates a level of deterioration of the mechanical brake devices 93.

The brake controller 31 includes a target braking force determiner 32 that determines, in accordance with the target deceleration, a target braking force, which is a target value of braking force for achieving a target deceleration indicated by the braking command contained in the operation command S1, and a regeneration controller 33 that controls the power conversion circuit controller 12. The brake controller 31 also includes a braking force adjuster 34 that adjusts the target braking force, and a mechanical brake controller 35 that controls the mechanical brake devices 93.

The target braking force determiner 32 calculates a target braking force by multiplying the target deceleration indicated by the braking command by the weight of the coach detected by the load detector 92. The target braking force determiner 32 outputs the calculated target braking force to the regeneration controller 33, the braking force adjuster 34, and the mechanical brake controller 35.

The regeneration controller 33 determines a target electric braking force from the target braking force, and outputs the regeneration pattern S3 indicating the target electric braking force to the power conversion circuit controller 12.

The braking force adjuster 34 adjusts the target braking force in accordance with a result of evaluation by the deterioration evaluating device 41. In detail, when the deterioration evaluating device 41 determines that deterioration occurs in the mechanical brake devices 93, the braking force adjuster 34 adjusts the target braking force and outputs the adjusted target braking force to the mechanical brake controller 35. In contrast, when the deterioration evaluating device 41 determines no deterioration in the mechanical brake devices 93, the braking force adjuster 34 outputs the target braking force acquired by the target braking force determiner 32 to the mechanical brake controller 35.

The mechanical brake controller 35 receives the regeneration feedback S4 indicating the actual electric braking force from the power conversion circuit controller 12. The mechanical brake controller 35 determines a target mechanical braking force, in accordance with the target braking force acquired from the target braking force determiner 32, the target braking force adjusted by the braking force adjuster 34, and the actual electric braking force. When the actual electric braking force is smaller than the target braking force acquired from the target braking force determiner 32, the mechanical brake controller 35 uses, as the target mechanical braking force, the difference between the target braking force acquired from the braking force adjuster 34 and the actual electric braking force.

When the deterioration evaluating device 41 detects any deterioration of the mechanical brake devices 93, the target braking force acquired from the braking force adjuster 34 is equal to the target braking force adjusted by the braking force adjuster 34 in accordance with the result of evaluation by the deterioration evaluating device 41. In contrast, when the deterioration evaluating device 41 detects no deterioration of the mechanical brake devices 93, the target braking force acquired from the braking force adjuster 34 is equal to the target braking force output from the target braking force determiner 32. The target mechanical braking force is thus adjusted in accordance with the result of evaluation by the deterioration evaluating device 41.

The mechanical brake controller 35 controls the mechanical brake devices 93, in accordance with the target mechanical braking force. In detail, the mechanical brake controller 35 determines a target pressure, which is a target value of pressure of air inside the brake cylinders included in the mechanical brake devices 93, on the basis of the target mechanical braking force. The mechanical brake controller 35 controls the mechanical brake devices 93, by adjusting the pressure of fluid fed from the air reservoir in accordance with the target pressure, and sending fluid having the adjusted pressure to the mechanical brake devices 93.

When the actual electric braking force is equal to or larger than the target braking force acquired from the target braking force determiner 32, the mechanical brake controller 35 does not control the mechanical brake devices 93, resulting in no generation of a mechanical braking force.

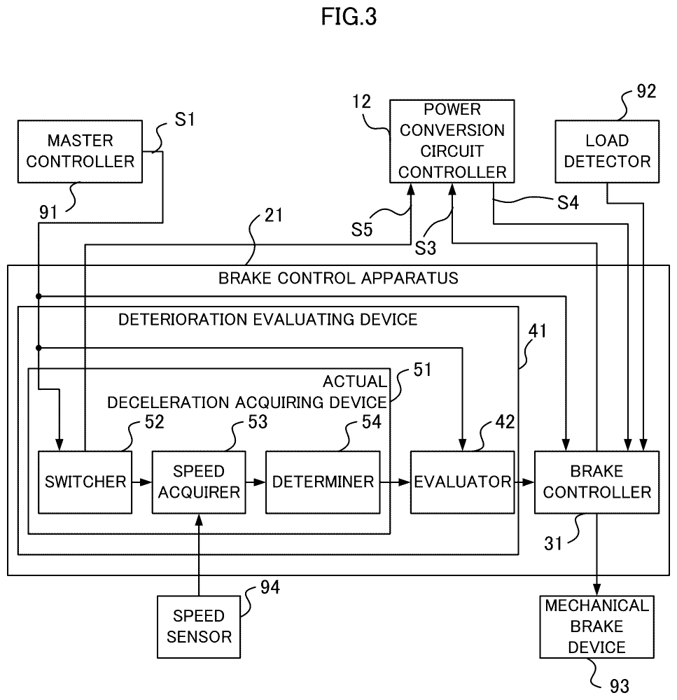

As illustrated in FIG. 3, the deterioration evaluating device 41 includes an actual deceleration acquiring device 51 that acquires an actual deceleration of the railway vehicle, and an evaluator 42 that evaluates a level of deterioration of the mechanical brake devices 93 in accordance with the actual deceleration acquired from the actual deceleration acquiring device 51.

The actual deceleration acquiring device 51 includes a switcher 52 that outputs the deactivation signal S5 for instructing deactivation of the power conversion circuit 11 to the power conversion circuit controller 12, a speed acquirer 53 that determines a speed of the railway vehicle on the basis of the values measured by the speed sensors 94, and a determiner 54 that determines an actual deceleration of the railway vehicle on the basis of a variation in speed of the railway vehicle in the subject period.

The switcher 52 outputs, in response to satisfaction of an initiation condition for initiating the process of acquiring an actual deceleration, the deactivation signal S5 for instructing deactivation of the power conversion circuit 11, specifically, instructing the power conversion circuit 11 to stop power conversion, to the power conversion circuit controller 12. The initiation condition is defined in accordance with the place where the railway vehicle is running, for example. The initiation condition is satisfied when the railway vehicle arrives at a brake starting position located in advance of a predetermined stop station for the first time in the day, for example. The stop station is preferably located in a place having a sufficiently small inclination. When the power conversion circuit 11 is deactivated while the operation command S1 is containing a braking command, the railway vehicle is decelerated by the mechanical braking force alone among the mechanical braking force and the electric braking force. The railway vehicle receives no electric braking force during deactivation of the power conversion circuit 11.

When the switcher 52 outputs the deactivation signal S5, the speed acquirer 53 acquires a speed of the railway vehicle on the basis of the values measured by the speed sensors 94 provided to the individual axles. For example, the speed acquirer 53, when receiving a notification that the switcher 52 has output the deactivation signal S5 from the switcher 52, determines a speed of the railway vehicle on the basis of the values measured by the speed sensors 94, and causes the determined speed to be stored into a storage device, which is not illustrated. For example, the speed acquirer 53 determines shaft speeds of the individual axles of the coach on the basis of the values measured by the speed sensors 94, and determines a speed of the vehicle on the basis of a reference shaft speed, which is the maximum value of the shaft speeds of the individual axles.

The speed acquirer 53 repeats determining a speed of the railway vehicle from the values measured by the speed sensors 94 and causing the speed to be stored into the storage device for a subject period, for example, a period from satisfaction of the initiation condition until stop of the railway vehicle. The speed acquirer 53 outputs the determined speeds of the railway vehicle for the subject period to the determiner 54.

The determiner 54 determines an actual deceleration of the railway vehicle, from a variation in speed of the railway vehicle in the subject period. The determiner 54 acquires an actual deceleration of the railway vehicle from a variation in speed of the railway vehicle in the subject period and the length of the subject period, on the basis of the speeds acquired by the speed acquirer 53. In Embodiment 1, the determiner 54 uses the speeds of the railway vehicle acquired in the subject period by the speed acquirer 53, specifically, a speed of the railway vehicle at the start of the subject period, and a speed of the railway vehicle at the end of the subject period, that is, 0 km/h.

The determiner 54 determines an actual deceleration β using Expression (1) below, for example. V1 in Expression (1) indicates an initial speed (unit: km/h), which is a speed at the start of the subject period, that is, a speed when the railway vehicle arrives at the brake starting position and starts braking. s in Expression (1) indicates a braking distance (unit: m), specifically, a distance from the brake starting position located in advance of a stop station to the stop station. s₀ in Expression (1) is represented by Expression (2) below. t₀ in Expression (2) is an idle running time. The determiner 54 is assumed to preliminarily retain information on the braking distance and the idle running time. The determiner 54 outputs the determined actual deceleration to the evaluator 42.

$$Expression 1$$

$$β = \frac{V {1}^{2}}{7.2 ( s - {s}_{0} )} \qquad ( 1 )$$

The evaluator 42 evaluates a level of deterioration of the mechanical brake devices 93, based on a comparison between the actual deceleration acquired from the actual deceleration acquiring device 51 and the target deceleration indicated by the braking command. In detail, the evaluator 42 evaluates a level of deterioration of the mechanical brake devices 93, on the basis of whether the ratio of the difference between the actual deceleration and the target deceleration to the target deceleration is within a target range.

For example, the evaluator 42 calculates the ratio by dividing the result of subtracting the absolute value of the target deceleration from the absolute value of the actual deceleration by the absolute value of the target deceleration. When the absolute value of the actual deceleration is smaller than the absolute value of the target deceleration, in other words, the railway vehicle fails to achieve the target deceleration and is not sufficiently decelerated, the ratio calculated as described above has a negative value. In contrast, when the absolute value of the actual deceleration is larger than the absolute value of the target deceleration, in other words, the railway vehicle is decelerated more rapidly than the target deceleration, the ratio calculated as described above has a positive value.

For example, when the absolute value of the ratio of the difference between the actual deceleration and the target deceleration to the target deceleration is within the target range of allowable braking performance of the mechanical brake devices 93, for example, the range equal to or larger than 0 and equal to or smaller than 0.15, no deterioration is deemed to occur in the mechanical brake devices 93. In contrast, when the absolute value of the ratio of the difference between the actual deceleration and the target deceleration to the target deceleration is larger than 0.15, any deterioration is deemed to occur in the mechanical brake devices 93.

The evaluator 42 outputs the result of evaluation and the ratio of the difference between the actual deceleration and the target deceleration to the target deceleration, to the brake controller 31. The evaluator 42 outputs an evaluation result signal to the brake controller 31 as the result of evaluation. The evaluation result signal is at a low (L) level when the ratio of the difference between the actual deceleration and the target deceleration to the target deceleration is within the target range, and at a high (H) level when the ratio of the difference between the actual deceleration and the target deceleration to the target deceleration is not within the target range, for example.

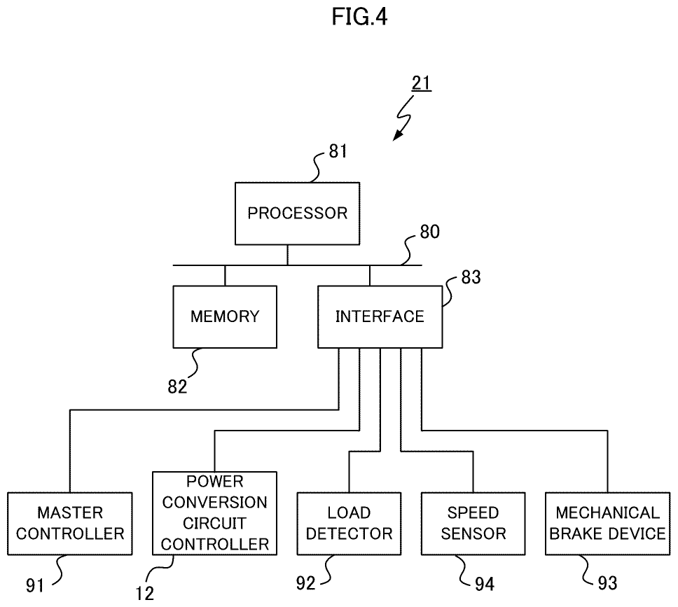

FIG. 4 illustrates hardware components of the brake control apparatus 21 having the above-described configuration. The brake control apparatus 21 includes a processor 81, a memory 82, and an interface 83. The processor 81, the memory 82, and the interface 83 are connected to each other via buses 80. The functions of the components of the brake control apparatus 21 are performed by software, firmware, or a combination of software and firmware. The software and firmware are described in the form of programs, and stored in the memory 82. The programs stored in the memory 82 are read and executed by the processor 81, and thus perform these functions of the components. That is, the memory 82 stores programs for the processes of the components of the brake control apparatus 21.

Examples of the memory 82 include non-volatile or volatile semiconductor memories, such as random access memory (RAM), read-only memory (ROM), flash memory, erasable programmable read-only memory (EPROM), and electrically erasable and programmable read-only memory (EEPROM), magnetic disks, flexible disks, optical disks, compact discs, mini discs, and digital versatile discs (DVDs).

The brake control apparatus 21 is connected to the master controller 91, the power conversion circuit controller 12, the load detector 92, the mechanical brake devices 93, and the speed sensors 94, via the interface 83. The interface 83 includes interface modules pursuant to one or more standards depending on connection destinations.

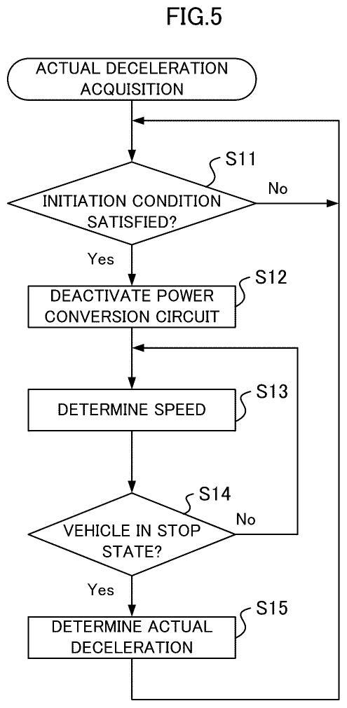

The actual deceleration acquiring device 51 of the brake control apparatus 21 having the above-described configuration executes an actual deceleration acquiring process, which is described below with reference to FIG. 5. The actual deceleration acquiring device 51 initiates the process illustrated in FIG. 5, at the start of running of the railway vehicle.

The switcher 52 determines whether the initiation condition for initiating the actual deceleration acquiring process is satisfied (step S11). When determining that the initiation condition is not satisfied (step S11; No), the processing in step S11 is repeated. In contrast, when determining that the initiation condition is satisfied (step S11; Yes), the switcher 52 outputs a deactivation signal S5 to the power conversion circuit controller 12, and thus deactivates the power conversion circuit 11 (step S12). In detail, the power conversion circuit controller 12, when receiving the deactivation signal S5 from the switcher 52, outputs the power conversion control signals S2 for turning off the switching elements of the power conversion circuit 11, to the power conversion circuit 11, resulting in deactivation of the power conversion circuit 11.

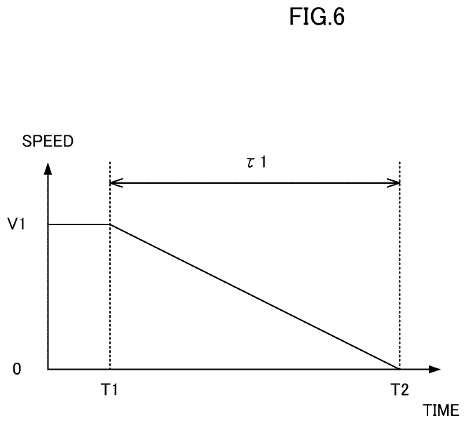

The description assumes an example in which the railway vehicle running at a speed V1 arrives at the brake starting position located in advance of a predetermined stop station at the time T1 for the first time in the day, and thus satisfies the initiation condition, as illustrated in FIG. 6. When the railway vehicle arrives at the brake starting position at the time T1, the master controller 91 outputs an operation command S1 containing a braking command to the brake control apparatus 21. In response to satisfaction of the initiation condition at the time T1, the power conversion circuit 11 is deactivated by the deactivation signal S5 output from the switcher 52, so that the railway vehicle is decelerated by a mechanical braking force alone after the time T1.

After completion of the processing in step S12 in FIG. 5, the speed acquirer 53 determines a speed of the railway vehicle from the values measured by the speed sensors 94 (step S13). On the basis of the speed of the railway vehicle determined in step S13, the speed acquirer 53 determines whether the railway vehicle is in a stop state (step S14). When determining that the railway vehicle is not in a stop state, in other words, while the railway vehicle is running (step S14; No), the processing in step S13 is repeated.

In contrast, when determining that the railway vehicle is in a stop state (step S14; Yes), the speed acquirer 53 outputs the speeds of the railway vehicle repetitively acquired for the subject period, to the determiner 54. The determiner 54 then determines, from the speeds of the railway vehicle acquired from the speed acquirer 53, an actual deceleration of the railway vehicle in the subject period (step S15). In detail, the determiner 54 determines an actual deceleration using Expression (1) above. In the example illustrated in FIG. 6, the railway vehicle is decelerated at a constant deceleration because of no change in the braking command for the period 11 from the time T1 until the time T2. The determiner 54 outputs the determined actual deceleration to the evaluator 42 of the deterioration evaluating device 41. Completion of the processing in step S15 in FIG. 5 is followed by repetition of step S11 and the subsequent steps.

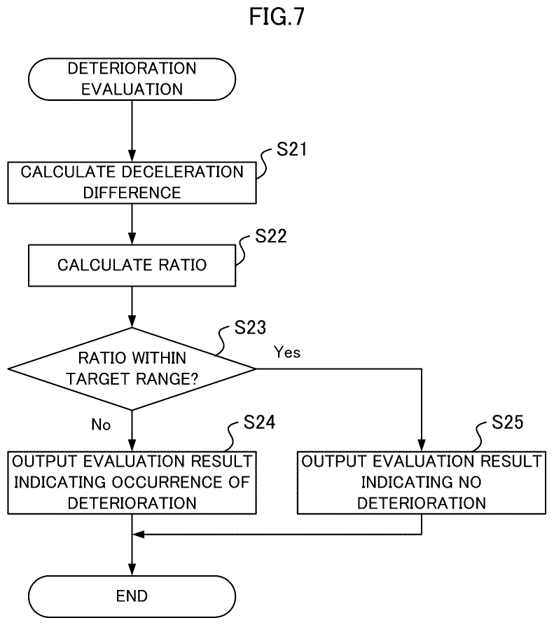

The deterioration evaluating device 41 executes a process of evaluating a level of deterioration of the mechanical brake devices 93 in accordance with the actual deceleration determined as described above by the actual deceleration acquiring device 51. The process of evaluating a level of deterioration is described below with reference to FIG. 7. The deterioration evaluating device 41 initiates the process illustrated in FIG. 7 in response to the determination of an actual deceleration by the actual deceleration acquiring device 51.

The evaluator 42 calculates a deceleration difference, which is the difference between the actual deceleration acquired from the actual deceleration acquiring device 51 and the target deceleration indicated by the braking command contained in the operation command S1 acquired from the master controller 91 (step S21). The evaluator 42 calculates a ratio of the difference between the actual deceleration and the target deceleration to the target deceleration, by dividing the deceleration difference calculated in step S21 by the target deceleration (step S22). The evaluator 42 evaluates whether the ratio calculated in step S22 is within the target range (step S23). When determining that the ratio calculated in step S22 is not within the target range (step S23; No), the evaluator 42 outputs a result of deterioration evaluation indicating occurrence of deterioration of the mechanical brake devices 93, to the brake controller 31 (step S24). The evaluator 42 preferably outputs, in addition to the result of deterioration evaluation, the ratio calculated in step S22 to the brake controller 31 in step S24. After completion of the processing in step S24, the deterioration evaluating device 41 terminates the deterioration evaluating process.

In contrast, when the evaluator 42 determines that the ratio calculated in step S22 is within the target range (step S23; Yes), the evaluator 42 outputs a result of deterioration evaluation indicating no deterioration of the mechanical brake devices 93 to the brake controller 31 (step S25). After completion of the processing in step S25, the deterioration evaluating device 41 terminates the deterioration evaluating process.

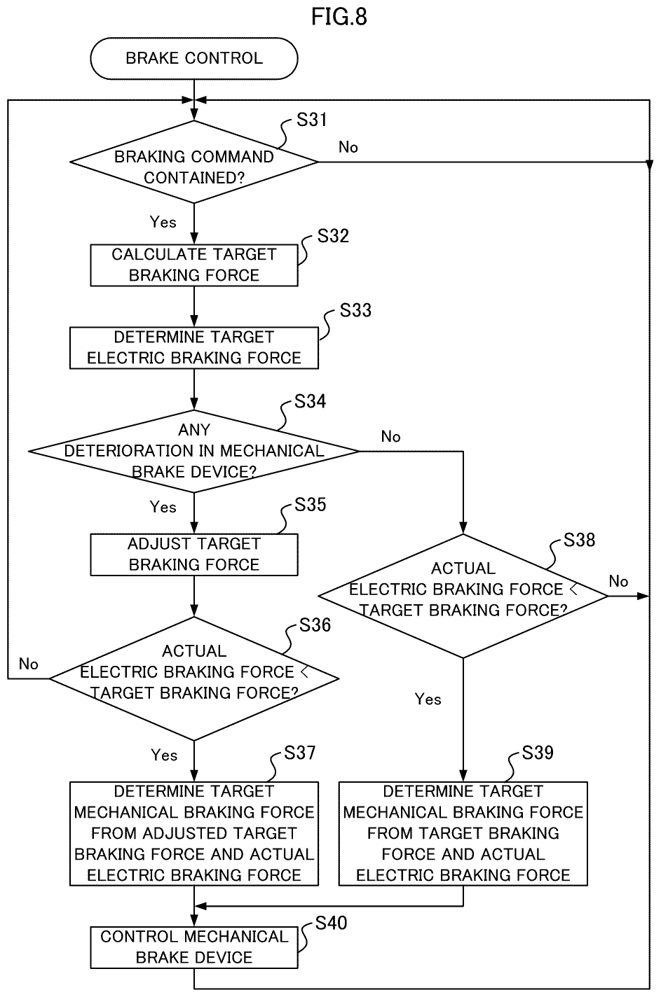

The brake control apparatus 21 executes a brake control process on the basis of the level of deterioration of the mechanical brake devices 93 evaluated as described above by the deterioration evaluating device 41. The brake control process executed by the brake control apparatus 21 is described below with reference to FIG. 8. The brake control apparatus 21 initiates the process illustrated in FIG. 8, at the start of operation of the railway vehicle.

The target braking force determiner 32 determines whether the operation command S1 contains a braking command (step S31). When the operation command S1 does not contain a braking command (step S31; No), the processing in step S31 is repeated. In contrast, when the operation command S1 contains a braking command (step S31; Yes), the target braking force determiner 32 calculates a target braking force, by multiplying the target deceleration indicated by the braking command, by the weight of the coach detected by the load detector 92 (step S32). The target braking force determiner 32 outputs the target braking force calculated in step S32, to the regeneration controller 33, the braking force adjuster 34, and the mechanical brake controller 35.

The regeneration controller 33 determines a target electric braking force from the target braking force calculated in step S32 (step S33). When the speed of the railway vehicle is within the speed range for achieving a sufficiently large regenerative braking force, the regeneration controller 33 uses the target braking force as the target electric braking force. The regeneration controller 33 outputs the regeneration pattern S3 indicating the target electric braking force to the power conversion circuit controller 12.

When the result of evaluation by the deterioration evaluating device 41 indicates occurrence of deterioration of the mechanical brake devices 93 (step S34; Yes), the braking force adjuster 34 adjusts the target braking force calculated in step S32 in accordance with the ratio calculated by the evaluator 42 (step S35).

When the result of evaluation by the deterioration evaluating device 41 indicates occurrence of deterioration of the mechanical brake devices 93 (step S34; Yes), and when the actual electric braking force indicated by the regeneration feedback S4 is smaller than the target braking force calculated in step S32 (step S36; Yes), the mechanical brake controller 35 determines a target mechanical braking force from the difference between the target braking force adjusted in step S35 and the actual electric braking force (step S37). For example, the mechanical brake controller 35 uses the difference between the target braking force adjusted in step S35 and the actual electric braking force as the target mechanical braking force.

When the result of evaluation by the deterioration evaluating device 41 indicates no deterioration of the mechanical brake devices 93 (step S34; No), and when the actual electric braking force indicated by the regeneration feedback S4 is smaller than the target braking force calculated in step S32 (step S38; Yes), the mechanical brake controller 35 determines a target mechanical braking force from the difference between the target braking force calculated in step S32 and the actual electric braking force (step S39). For example, the mechanical brake controller 35 uses the difference between the target braking force calculated in step S32 and the actual electric braking force as the target mechanical braking force.

The mechanical brake controller 35 controls the mechanical brake devices 93, in accordance with the target mechanical braking force determined in step S37 or S39 (step S40). Completion of the processing in step S40 is followed by repetition of step S31 and the subsequent steps.

When the result of evaluation by the deterioration evaluating device 41 indicates occurrence of deterioration of the mechanical brake devices 93 (step S34; Yes), and when the actual electric braking force indicated by the regeneration feedback S4 is not smaller than the target braking force calculated in step S32, in other words, the actual electric braking force indicated by the regeneration feedback S4 is equal to or larger than the target braking force calculated in step S32 (step S36; No), the mechanical brake controller 35 does not activate the mechanical brake devices 93, and the brake control apparatus 21 repeats the above-described processing in step S31 and the subsequent steps.

When the result of evaluation by the deterioration evaluating device 41 indicates no deterioration of the mechanical brake devices 93 (step S34; No), and when the actual electric braking force indicated by the regeneration feedback S4 is not smaller than the target braking force calculated in step S32, in other words, the actual electric braking force indicated by the regeneration feedback S4 is equal to or larger than the target braking force calculated in step S32 (step S38; No), the mechanical brake controller 35 does not activate the mechanical brake devices 93, and the brake control apparatus 21 repeats the above-described processing in step S31 and the subsequent steps.

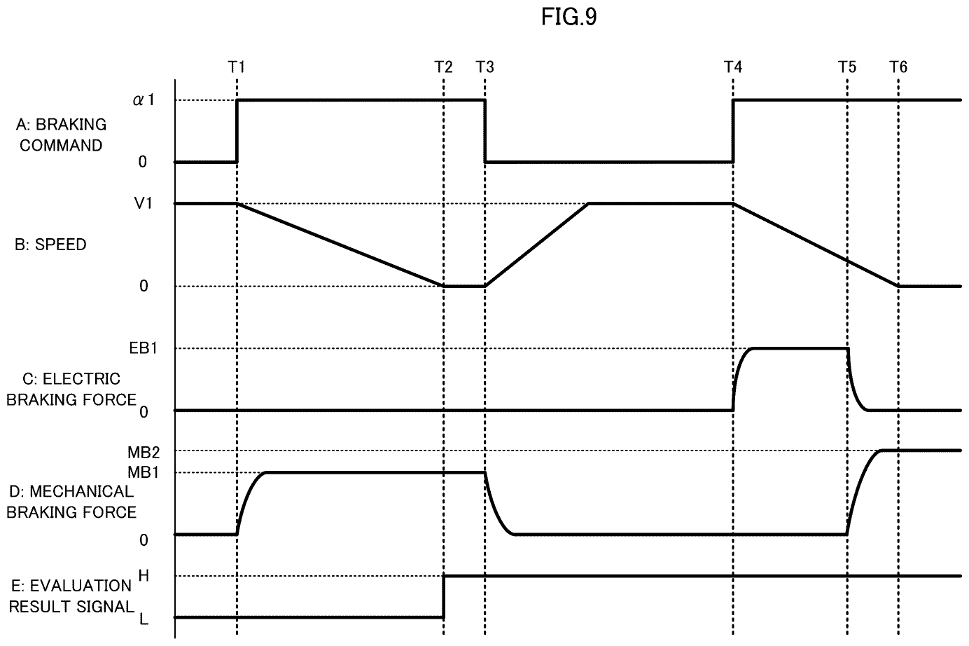

FIG. 9 is a timing chart illustrating operations of the brake control apparatus 21, which executes the acquisition of an actual deceleration of the railway vehicle, the evaluation of deterioration of the mechanical brake devices 93, and the brake control, as described above. As illustrated in the graph A of FIG. 9, T1 indicates a time when the railway vehicle arrives at the brake starting position located in advance of a predetermined stop station, and the operation command S1 containing a braking command indicating a target deceleration α1 is input into the brake control apparatus 21. At the time T1, the initiation condition for initiating the process of acquiring an actual deceleration is satisfied, and the switcher 52 outputs the deactivation signal S5, resulting in deactivation of the power conversion circuit 11. At the time T1, the speed acquirer 53 acquires a speed V1 of the railway vehicle.

The deterioration evaluating device 41 is assumed to evaluate no deterioration of the mechanical brake devices 93 at the time T1. The evaluation result signal output from the deterioration evaluating device 41 is thus at an L level, as illustrated in the graph E of FIG. 9.

In response to input of the braking command at the time T1, the target braking force determiner 32 of the brake controller 31 determines a target braking force. The regeneration controller 33 determines a target electric braking force in accordance with the target braking force, and outputs the regeneration pattern S3 indicating the target electric braking force to the power conversion circuit controller 12. The power conversion circuit controller 12 receives the deactivation signal S5 from the switcher 52 at the time T1, and thus outputs the power conversion control signals S2 for turning off the switching elements of the power conversion circuit 11 to the power conversion circuit 11, regardless of the regeneration pattern S3. Therefore, no electric braking force is generated, as illustrated in the graph C of FIG. 9. The power conversion circuit controller 12 outputs the regeneration feedback S4 indicating no electric braking force to the brake control apparatus 21.

On the basis of the evaluation result signal at an L level at the time T1, as illustrated in the graph E of FIG. 9, the braking force adjuster 34 outputs the target braking force acquired from the target braking force determiner 32, to the mechanical brake controller 35.

Because of the actual electric braking force smaller than the target braking force acquired from the target braking force determiner 32, the mechanical brake controller 35 uses the difference between the target braking force acquired from the braking force adjuster 34 and the actual electric braking force as the target mechanical braking force. The target braking force acquired from the braking force adjuster 34 is equal to the target braking force determined by the target braking force determiner 32, as described above. The mechanical brake controller 35 controls the mechanical brake devices 93 in accordance with the target mechanical braking force, and thus generates a mechanical braking force, which increases to MB1, as illustrated in the graph D of FIG. 9. The railway vehicle is thus decelerated after the time T1, as illustrated in the graph B of FIG. 9.

The decelerating railway vehicle stops running at a time T2. When the railway vehicle stops at the time T2, the determiner 54 of the actual deceleration acquiring device 51 determines an actual deceleration of the railway vehicle from a variation in speed of the railway vehicle in the subject period from the time T1 until the time T2, on the basis of the speeds of the railway vehicle acquired by the speed acquirer 53.

The evaluator 42 evaluates a level of deterioration of the mechanical brake devices 93, based on a comparison between the actual deceleration acquired from the actual deceleration acquiring device 51 and the target deceleration indicated by the braking command. For example, when the ratio of the difference between the actual deceleration and the target deceleration to the target deceleration is not within the target range, the evaluator 42 outputs the evaluation result signal at an H level, to the brake controller 31 of the brake control apparatus 21, as illustrated in the graph E of FIG. 9.

The railway vehicle that has stopped running at the time T2 starts accelerating at a time T3. When the master controller 91 is manipulated to instruct the railway vehicle to accelerate at the time T3, the brake control apparatus 21 receives no operation command S1 containing a braking command, and thus reduces the pressure of air inside the brake cylinders included in the mechanical brake devices 93. As a result, the mechanical braking force starts decreasing at the time T3, as illustrated in the graph D of FIG. 9. The railway vehicle starts to accelerate at the time T3 and allows the speed of the railway vehicle to reach V1, as illustrated in the graph B of FIG. 9.

The master controller 91 is then manipulated to instruct the railway vehicle to decelerate at a time T4. The description assumes that the initiation condition for initiating the process of acquiring an actual deceleration executed by the actual deceleration acquiring device 51 is not satisfied at the time T4. The switcher 52 thus does not output the deactivation signal S5 to the power conversion circuit controller 12.

In response to input of the operation command S1 containing a braking command into the brake control apparatus 21 at the time T4, the target braking force determiner 32 of the brake controller 31 determines a target braking force. The regeneration controller 33 determines a target electric braking force in accordance with the target braking force, and outputs the regeneration pattern S3 indicating the target electric braking force to the power conversion circuit controller 12. The power conversion circuit controller 12 outputs the power conversion control signals S2 that correspond to the regeneration pattern S3, to the power conversion circuit 11.

The power conversion circuit 11, which includes the switching elements controlled by the power conversion control signals S2, converts AC power fed from the motors IM1 into DC power, and charges the filter capacitor FC1 with the DC power. The filter capacitor FC1 feeds electric power via a power supply line, such as overhead wire, to other railway vehicles during power running in the vicinity, followed by consumption of the electric power generated by the motors IM1 serving as electric generators. The electric braking force thus starts increasing at the time T4 and reaches EB1, as illustrated in the graph C of FIG. 9. The increase in the electric braking force causes the speed of the railway vehicle to start decreasing from V1 at the time T4, as illustrated in the graph B of FIG. 9.

The actual electric braking force becomes smaller than the target braking force at a time T5, in accordance with a reduction in the speed of the railway vehicle. No mechanical braking force is generated by the mechanical brake devices 93 until the time T5, because of the actual electric braking force equal to or larger than the target braking force.

On the basis of the evaluation result signal at an H level at the time T5 as illustrated in the graph E of FIG. 9, the braking force adjuster 34 adjusts the target braking force acquired from the target braking force determiner 32, and outputs the adjusted target braking force to the mechanical brake controller 35. In detail, the braking force adjuster 34 adjusts the target braking force in accordance with the ratio acquired from the evaluator 42 of the deterioration evaluating device 41. In an exemplary case of a negative ratio acquired from the evaluator 42 due to an insufficient braking force generated by the deteriorated mechanical brake devices 93, the braking force adjuster 34 adds, to the target braking force, the product of the target braking force and the absolute value of the ratio, and thus adjusts the target braking force.

When the actual electric braking force becomes smaller than the target braking force determined by the target braking force determiner 32 at the time T5, the mechanical brake controller 35 uses the difference between the adjusted target braking force acquired from the braking force adjuster 34 and the actual electric braking force as the target mechanical braking force.

The mechanical brake controller 35 controls the mechanical brake devices 93 in accordance with the target mechanical braking force, and thus generates a mechanical braking force, as illustrated in the graph D of FIG. 9. The mechanical brake controller 35 controls the mechanical brake devices 93 in accordance with the target mechanical braking force depending on the difference between the adjusted target braking force and the actual electric braking force, and thus causes the mechanical brake devices 93 to generate a mechanical braking force MB2 larger than MB1, as illustrated in the graph D of FIG. 9.

The mechanical braking force generated as described above allows the railway vehicle to decelerate at a constant deceleration, despite of a reduction in the electric braking force after the time T5 as illustrated in the graph C of FIG. 9. The railway vehicle accordingly stops running at a time T6.

The mechanical braking force generated in the control based on the difference between the target braking force determined based on the target deceleration and the actual electric braking force is the mechanical braking force MB1 due to deterioration of the mechanical brake devices 93. In the case of occurrence of deterioration of the mechanical brake devices 93, the brake controller 31 controls the mechanical brake devices 93, by using, as the target mechanical braking force, the difference between the actual electric braking force and the target braking force, which is adjusted in accordance with the ratio of the difference between the actual deceleration and the target deceleration to the target deceleration, as described above. As a result, the mechanical braking force MB2 larger than MB1 can be generated. The control can thus reduce the deviation of the actual deceleration from the target deceleration due to deterioration of the mechanical brake devices 93.

As described above, the actual deceleration acquiring device 51 according to Embodiment 1 deactivates the power conversion circuit 11, and acquires an actual deceleration of the railway vehicle being decelerated by the mechanical braking force alone, among the mechanical braking force and the electric braking force. The actual deceleration acquiring device 51 can thus acquire the actual deceleration of the railway vehicle caused by the mechanical braking force.

The deterioration evaluating device 41 evaluates a level of deterioration of the mechanical brake devices 93 in accordance with the actual deceleration of the railway vehicle caused by the mechanical braking force, and can thus achieve the highly accurate evaluation.

The brake control apparatus 21 executes the brake control in accordance with the result of evaluation by the deterioration evaluating device 41. In detail, when the deterioration evaluating device 41 detects any deterioration of the mechanical brake devices 93, the brake control apparatus 21 adjusts the target braking force, and controls the mechanical brake devices 93, by using, as the target mechanical braking force, the difference between the actual electric braking force and the target braking force, which is adjusted in accordance with the ratio of the difference between the adjusted actual deceleration and the target deceleration to the target deceleration. The deviation of the actual deceleration from the target deceleration due to deterioration of the mechanical brake devices 93 can be thus reduced.

### Embodiment 2

The actual deceleration acquiring device 51 may adjust the actual deceleration determined from the speeds of the railway vehicle being decelerated by the mechanical braking force, depending on the external environment. The description of Embodiment 2 demonstrates the brake control apparatus 21 including an actual deceleration acquiring device 51 that adjusts the actual deceleration in accordance with an inclination of the place where the railway vehicle is running, focusing on the differences from Embodiment 1.

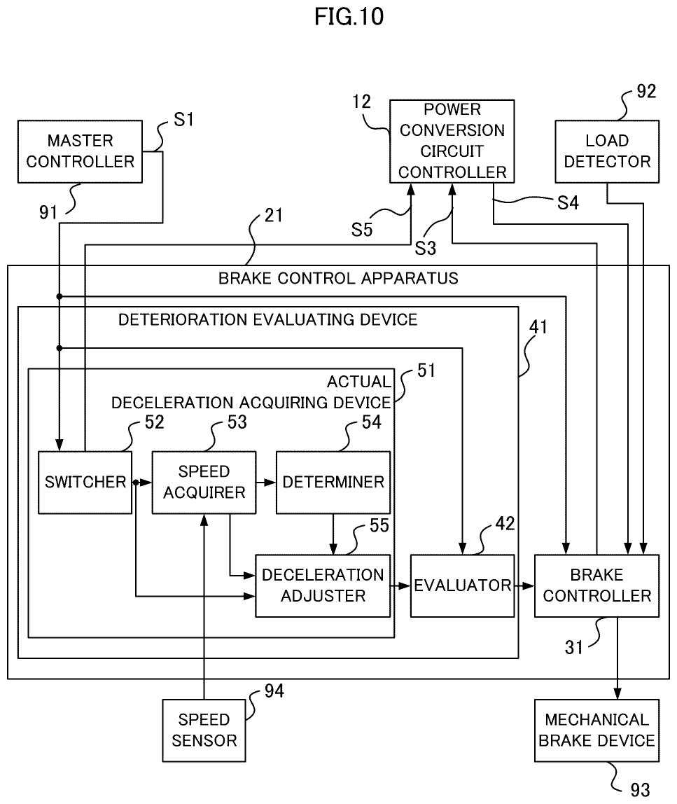

As illustrated in FIG. 10, the actual deceleration acquiring device 51 includes, in addition to the components of the actual deceleration acquiring device 51 according to Embodiment 1, a deceleration adjuster 55 that adjusts the actual deceleration determined by the determiner 54 in accordance with the place where the railway vehicle is running.

The switcher 52 outputs a notification that the switcher 52 has output the deactivation signal S5, to the speed acquirer 53 and the deceleration adjuster 55.

The speed acquirer 53 notifies the deceleration adjuster 55 that the railway vehicle has stopped, when the speeds acquired from the speed sensors 94 reach 0.

The deceleration adjuster 55, when receiving the notification that the switcher 52 has output the deactivation signal S5 from the switcher 52, acquires information on an inclination of the place where the railway vehicle is running from an automatic train operation (ATO) device, which is not illustrated. The deceleration adjuster 55 repeats acquiring information on an inclination of the place where the railway vehicle is running until being notified that the railway vehicle has stopped from the switcher 52.

The deceleration adjuster 55 adjusts the actual deceleration determined by the determiner 54, in accordance with the inclination of the place where the railway vehicle is running for the period from deactivation of the power conversion circuit 11 in response to the deactivation signal S5 until stop of the railway vehicle caused by the mechanical braking force, in other words, for the subject period. A typical example of the inclination of the place where the railway vehicle is running for the subject period is the average of inclinations of the place where the railway vehicle is running in the subject period.

In an exemplary case of the railway vehicle running on an ascending slope for the subject period, the deceleration adjuster 55 increases the absolute value of the actual deceleration determined by the determiner 54. In another exemplary case of the railway vehicle running on a descending slope for the subject period, the deceleration adjuster 55 decreases the absolute value of the actual deceleration determined by the determiner 54. The deceleration adjuster 55 outputs the actual deceleration adjusted as described above, to the evaluator 42.

For example, the deceleration adjuster 55 adjusts the actual deceleration by applying the braking distance s′ represented in Expression (3) below as the braking distance s in Expression (1) above. i in Expression (3) indicates an inclination, which has a positive value in the case of an ascending slope and has a negative value in the case of a descending slope.

$$Expression 2$$

$${s}_{0} = \frac{V 1 \cdot {t}_{0}}{3.6} \qquad ( 2 )$$

The evaluator 42 of the deterioration evaluating device 41 evaluates a level of deterioration of the mechanical brake devices 93, on the basis of the actual deceleration adjusted by the deceleration adjuster 55.

Unlike Embodiment 1, the brake controller 31 of the brake control apparatus 21 according to Embodiment 2 controls the power conversion circuit controller 12 and the mechanical brake devices 93 in accordance with the adjusted target braking force, when the deterioration evaluating device 41 detects any deterioration of the mechanical brake devices 93.

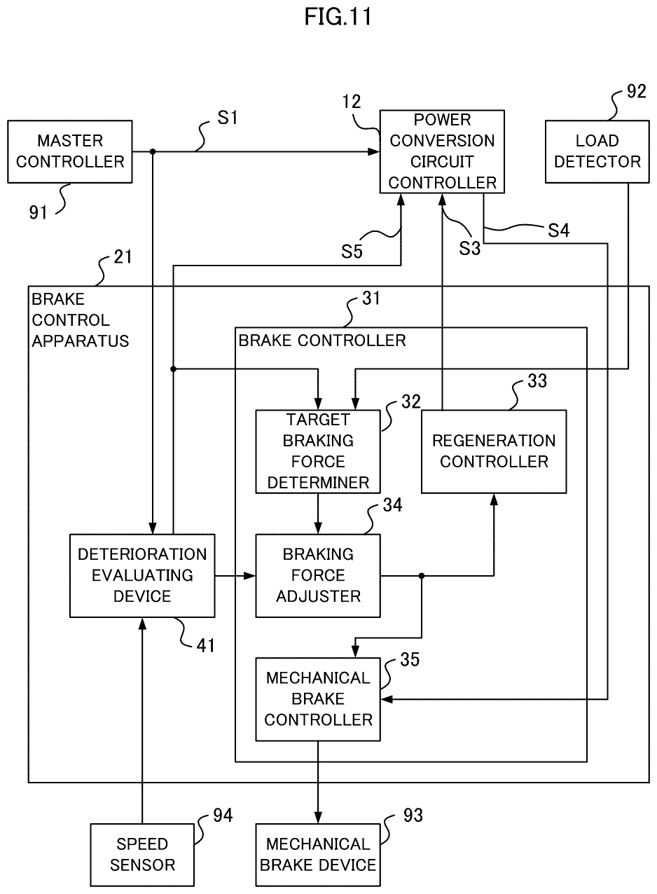

As illustrated in FIG. 11, the brake controller 31 has the same configuration as that in Embodiment 1. The target braking force determiner 32 outputs the target braking force determined as in Embodiment 1, to the braking force adjuster 34.

The braking force adjuster 34 adjusts the target braking force in accordance with the result of evaluation by the deterioration evaluating device 41. In detail, when the deterioration evaluating device 41 detects no deterioration of the mechanical brake devices 93, the braking force adjuster 34 outputs the target braking force acquired from the target braking force determiner 32, to the regeneration controller 33 and the mechanical brake controller 35. In contrast, when the evaluator 42 of the deterioration evaluating device 41 detects any deterioration of the mechanical brake devices 93, the braking force adjuster 34 adjusts the target braking force, in accordance with the ratio acquired from the evaluator 42 of the deterioration evaluating device 41, and outputs the adjusted target braking force to the regeneration controller 33 and the mechanical brake controller 35.

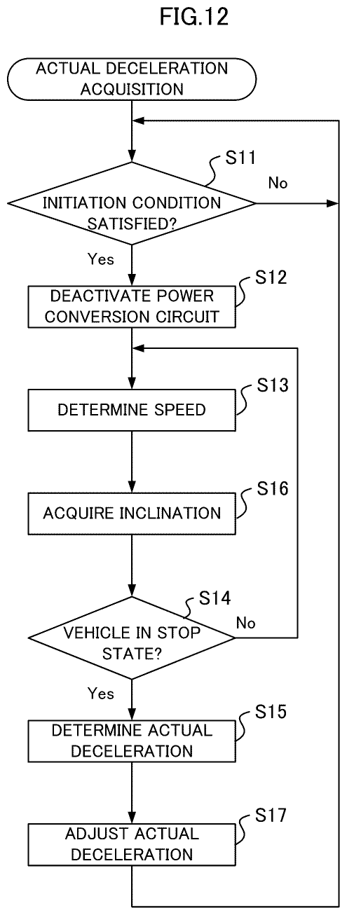

The brake control apparatus 21 includes the same hardware components as those in Embodiment 1. The actual deceleration acquiring device 51 having the above-described configuration executes an actual deceleration acquiring process, which is described below with reference to FIG. 12. The actual deceleration acquiring device 51 initiates the process illustrated in FIG. 12, at the start of running of the railway vehicle. The processing in steps S11 to S13 is the same as the processing in steps S11 to S13 in FIG. 5 executed by the actual deceleration acquiring device 51 according to Embodiment 1.

The deceleration adjuster 55 acquires an inclination of the place where the railway vehicle is running (step S16). The speed acquirer 53 determines whether the railway vehicle is in a stop state, on the basis of the speed of the railway vehicle determined in step S13 (step S14). When the railway vehicle is not in a stop state, in other words, while the railway vehicle is running (step S14; No), the processing in steps S13 and S16 is repeated.

In contrast, when determining that the railway vehicle is in a stop state (step S14; Yes), the determiner 54 determines an actual deceleration of the railway vehicle in the subject period, from the speeds of the railway vehicle acquired from the speed acquirer 53 (step S15). The deceleration adjuster 55 then adjusts the actual deceleration determined in step S15, in accordance with the inclination of the place where the railway vehicle is running for the subject period (step S17). Completion of the processing in step S17 is followed by repetition of the processing in step S11 and the subsequent steps.

The deterioration evaluating device 41 executes the same deterioration evaluating process as that in Embodiment 1.

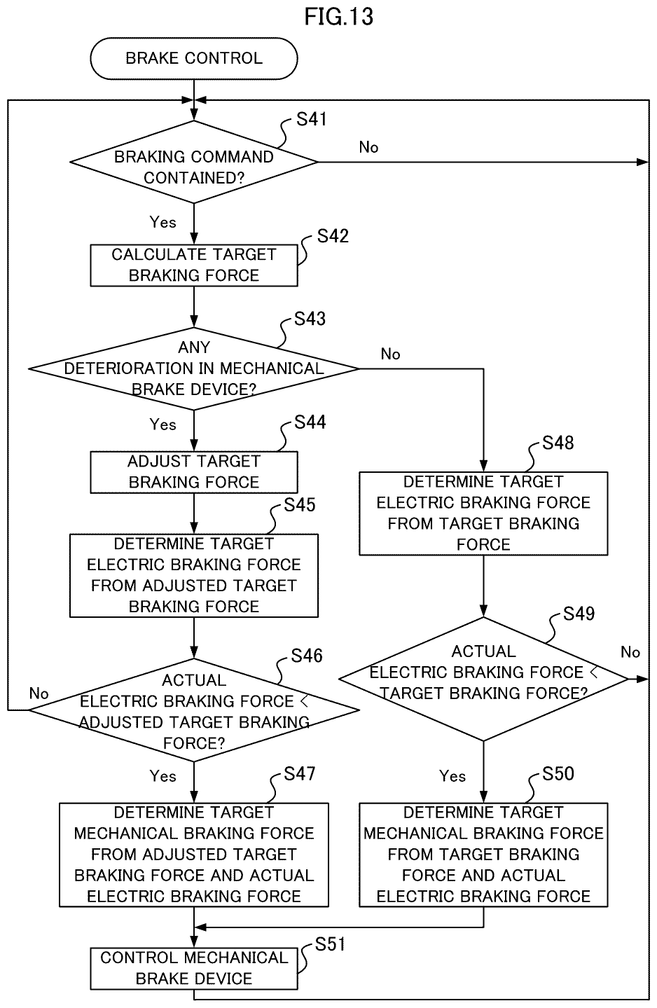

The brake control apparatus 21 executes a brake control process, which is described below with reference to FIG. 13. The brake control apparatus 21 initiates the process illustrated in FIG. 13, at the start of running of the railway vehicle.

The target braking force determiner 32 determines whether the operation command S1 contains a braking command (step S41). When the operation command S1 does not contain a braking command (step S41; No), the processing in step S41 is repeated. In contrast, when the operation command S1 contains a braking command (step S41; Yes), the target braking force determiner 32 calculates a target braking force, by multiplying the target deceleration indicated by the braking command by the weight of the coach detected by the load detector 92 (step S42). The target braking force determiner 32 outputs the target braking force calculated in step S42 to the braking force adjuster 34.

When the result of evaluation by the deterioration evaluating device 41 indicates occurrence of deterioration of the mechanical brake devices 93 (step S43; Yes), the braking force adjuster 34 adjusts the target braking force calculated in step S42, in accordance with the ratio calculated by the evaluator 42 (step S44). The braking force adjuster 34 outputs the adjusted target braking force to the regeneration controller 33 and the mechanical brake controller 35.

The regeneration controller 33 determines a target electric braking force from the target braking force adjusted in step S44 (step S45). When the speed of the railway vehicle is within the range for achieving a sufficiently large regenerative braking force, the regeneration controller 33 uses the target braking force as the target electric braking force. The regeneration controller 33 outputs the regeneration pattern S3 indicating the target electric braking force to the power conversion circuit controller 12.

When the actual electric braking force indicated by the regeneration feedback S4 is not smaller than the adjusted target braking force, in other words, the actual electric braking force indicated by the regeneration feedback S4 is equal to or larger than the adjusted target braking force (step S46; No), the mechanical brake controller 35 does not activate the mechanical brake devices 93, and the brake control apparatus 21 repeats the above-described processing in step S41 and the subsequent steps.

In contrast, when the actual electric braking force is smaller than the adjusted target braking force (step S46; Yes), the mechanical brake controller 35 determines a target mechanical braking force, from the difference between the target braking force adjusted in step S44 and the actual electric braking force (step S47). For example, the mechanical brake controller 35 uses the difference between the target braking force adjusted in step S44 and the actual electric braking force as the target mechanical braking force.

When the result of evaluation by the deterioration evaluating device 41 indicates no deterioration of the mechanical brake devices 93 (step S43; No), the braking force adjuster 34 skips the processing in step S44. That is, the target braking force output from the braking force adjuster 34 to the regeneration controller 33 and the mechanical brake controller 35 is equal to the target braking force calculated by the target braking force determiner 32. When the result of evaluation by the deterioration evaluating device 41 indicates no deterioration of the mechanical brake devices 93 (step S43; No), the regeneration controller 33 determines a target electric braking force from the target braking force calculated in step S42 (step S48). When the speed of the railway vehicle is within the range for achieving a sufficiently large regenerative braking force, the regeneration controller 33 uses the target braking force as the target electric braking force. The regeneration controller 33 outputs the regeneration pattern S3 indicating the target electric braking force to the power conversion circuit controller 12.

When the actual electric braking force indicated by the regeneration feedback S4 is not smaller than the target braking force calculated in step S42, in other words, the actual electric braking force indicated by the regeneration feedback S4 is equal to or larger than the target braking force calculated in step S42 (step S49; No), the mechanical brake controller 35 does not activate the mechanical brake devices 93, and the brake control apparatus 21 repeats the above-described processing in step S41 and the subsequent steps as described above.

In contrast, when the actual electric braking force is smaller than the target braking force calculated in step S42 (step S49; Yes), the mechanical brake controller 35 determines a target mechanical braking force from the difference between the target braking force calculated in step S42 and the actual electric braking force (step S50). For example, the mechanical brake controller 35 uses the difference between the target braking force calculated in step S42 and the actual electric braking force as the target mechanical braking force.

The mechanical brake controller 35 controls the mechanical brake devices 93, in accordance with the target mechanical braking force determined in step S47 or S50 (step S51). Completion of the processing in step S51 is followed by repetition of the processing in step S41 and the subsequent steps.

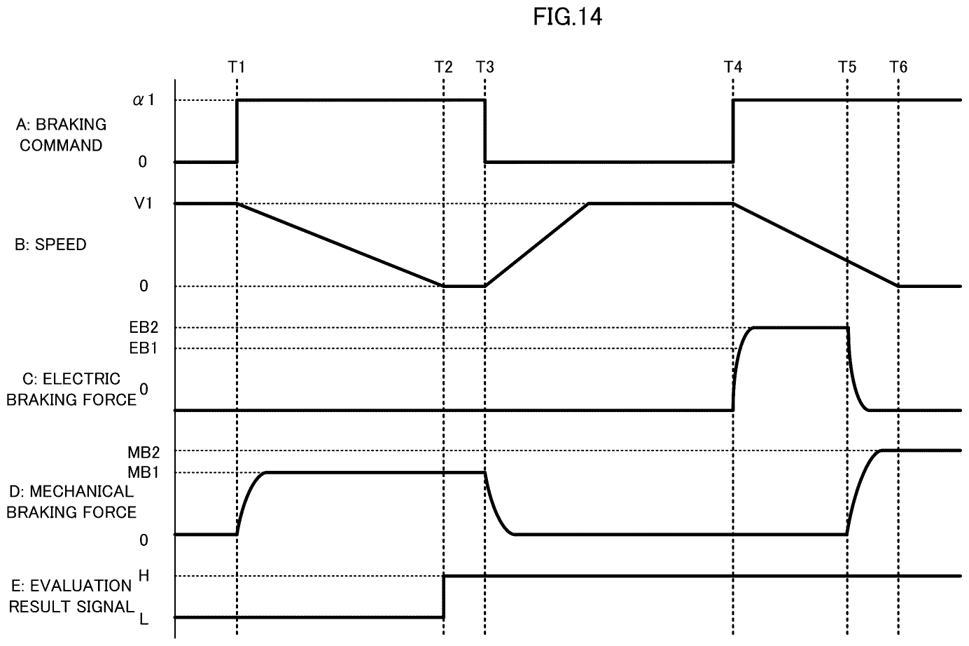

FIG. 14 is a timing chart illustrating operations of the brake control apparatus 21 that executes the acquisition of an actual deceleration of the railway vehicle, the evaluation of deterioration of the mechanical brake devices 93, and the brake control, as described above. The operations of the brake control apparatus 21 until the time T4 are the same as the operations of the brake control apparatus 21 illustrated in FIG. 9.

In response to input of the operation command S1 containing a braking command into the brake control apparatus 21 at the time T4, the target braking force determiner 32 of the brake controller 31 determines a target braking force. On the basis of the evaluation result signal at an H level at the time T4 as illustrated in the graph E of FIG. 14, the braking force adjuster 34 adjusts the target braking force in accordance with the ratio calculated by the evaluator 42, and outputs the adjusted target braking force to the regeneration controller 33 and the mechanical brake controller 35. In an exemplary case of a negative ratio acquired from the evaluator 42 due to an insufficient braking force generated by the deteriorated mechanical brake devices 93, the braking force adjuster 34 adds, to the target braking force, the product of the target braking force and the absolute value of the ratio, and thus adjusts the target braking force.

The regeneration controller 33 determines a target electric braking force in accordance with the adjusted target braking force, and outputs the regeneration pattern S3 indicating the target electric braking force to the power conversion circuit controller 12. The power conversion circuit controller 12 outputs the power conversion control signals S2 that correspond to the regeneration pattern S3, to the power conversion circuit 11. The electric braking force thus starts to increase at the time T4 and reaches EB2, as illustrated in the graph C of FIG. 14. The electric braking force EB2 is larger than the electric braking force EB1 generated in Embodiment 1, because the target electric braking force used in the control is based on the target braking force adjusted to be larger in accordance with deterioration of the mechanical brake devices 93. The actual electric braking force becomes smaller than the adjusted target braking force at a time T5, in accordance with a reduction in the speed of the railway vehicle. The operations of the brake control apparatus 21 after the time T5 are the same as those in Embodiment 1.

As described above, the actual deceleration acquiring device 51 according to Embodiment 2 deactivates the power conversion circuit 11, acquires an actual deceleration of the railway vehicle being decelerated by the mechanical braking force, and adjusts the actual deceleration in accordance with the inclination of the place where the railway vehicle is running. The actual deceleration acquiring device 51 can thus acquire the actual deceleration of the railway vehicle caused by the mechanical braking force with high accuracy.

The deterioration evaluating device 41 evaluates a level of deterioration of the mechanical brake devices 93 in accordance with the actual deceleration of the railway vehicle caused by the mechanical braking force and adjusted in accordance with the inclination of the place where the railway vehicle is running, and can thus achieve the highly accurate evaluation.

The brake control apparatus 21 executes the brake control in accordance with the result of evaluation by the deterioration evaluating device 41. In detail, when the deterioration evaluating device 41 detects any deterioration of the mechanical brake devices 93, the brake control apparatus 21 adjusts the target braking force, and determines a target electric braking force and a target mechanical braking force in accordance with the adjusted target braking force. The deviation of the actual deceleration from the target deceleration due to deterioration of the mechanical brake devices 93 can thus be reduced.

### Embodiment 3

The level of deterioration of the mechanical brake devices 93 may be evaluated by procedures other than that in the above-described examples. The description of Embodiment 3 demonstrates a deterioration evaluating device 41 that evaluates deterioration by a procedure different from that in Embodiments 1 and 2, focusing on the differences from Embodiments 1 and 2.

The deterioration evaluating device 41 according to Embodiment 3 has the same configuration as that in Embodiment 1. The evaluator 42 of the deterioration evaluating device 41 according to Embodiment 3 acquires an actual deceleration of another railway vehicle, from an actual deceleration acquiring device of a deterioration evaluating device of a brake control apparatus installed in the other railway vehicle. The evaluator 42 evaluates a level of deterioration of the mechanical brake devices 93, based on a comparison between the actual deceleration acquired from the actual deceleration acquiring device 51 and the actual deceleration of the other railway vehicle. In detail, the evaluator 42 determines whether the difference in actual deceleration, which is the difference between the actual deceleration acquired from the actual deceleration acquiring device 51 and the actual deceleration of the other railway vehicle, is within a target range of allowable braking performance of the mechanical brake devices 93. When the difference in actual deceleration is within the target range, no deterioration is deemed to occur in the mechanical brake devices 93. In contrast, when the difference in actual deceleration is not within the target range, any deterioration is deemed to occur in the mechanical brake devices 93.

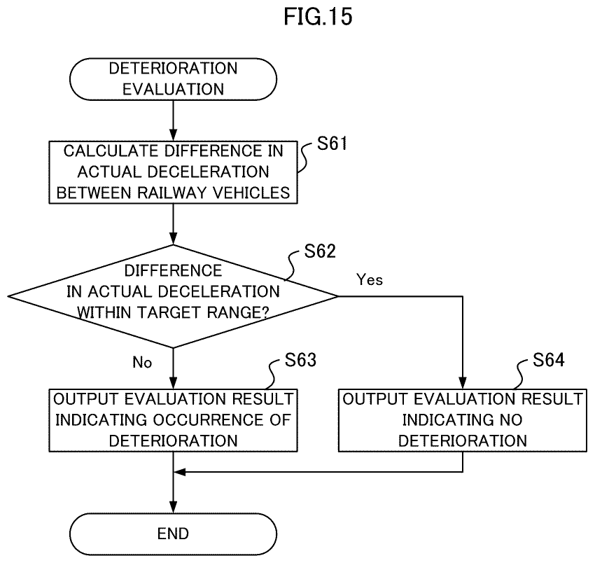

The deterioration evaluating device 41 executes a process of evaluating a level of deterioration of the mechanical brake devices 93, in accordance with the actual deceleration determined as described above by the actual deceleration acquiring device 51, which is described below with reference to FIG. 15. The deterioration evaluating device 41 initiates the process illustrated in FIG. 15, in response to the determination of an actual deceleration by the actual deceleration acquiring device 51 and the acquisition of an actual deceleration of the other railway vehicle.

The evaluator 42 calculates a difference in actual deceleration, which is the difference between the actual deceleration acquired from the actual deceleration acquiring device 51 and the actual deceleration of the other railway vehicle (step S61). The evaluator 42 then determines whether the difference in actual deceleration calculated in step S61 is within the target range (step S62). When determining that the difference in actual deceleration calculated in step S61 is not within the target range (step S62; No), the evaluator 42 outputs the result of deterioration evaluation indicating occurrence of deterioration of the mechanical brake devices 93, to the brake controller 31 (step S63). Specifically, the evaluator 42 outputs the evaluation result signal at an H level to the brake controller 31.

In contrast, when determining that the difference in actual deceleration calculated in step S61 is within the target range (step S62; Yes), the evaluator 42 outputs the result of deterioration evaluation indicating no deterioration of the mechanical brake devices 93, to the brake controller 31 (step S64). Specifically, the evaluator 42 outputs the evaluation result signal at an L level to the brake controller 31. Completion of the processing in step S63 or S64 is followed by termination of the deterioration evaluating process.

As described above, the deterioration evaluating device 41 according to Embodiment 3 evaluates a level of deterioration of the mechanical brake devices 93 in accordance with the difference between the actual deceleration of the railway vehicle caused by the mechanical braking force and the actual deceleration of the other railway vehicle, and can thus achieve the highly accurate evaluation.

The above-described embodiments are not to be construed as limiting the scope of the present disclosure. Some of the embodiments may be arbitrarily combined with each other. The brake control apparatus 21 according to Embodiment 1 may execute the brake control similar to that executed by the brake control apparatus 21 according to Embodiment 2. The brake control apparatus 21 according to Embodiment 1 may execute the deterioration evaluating process similar to that executed by the deterioration evaluating device 41 according to Embodiment 3.

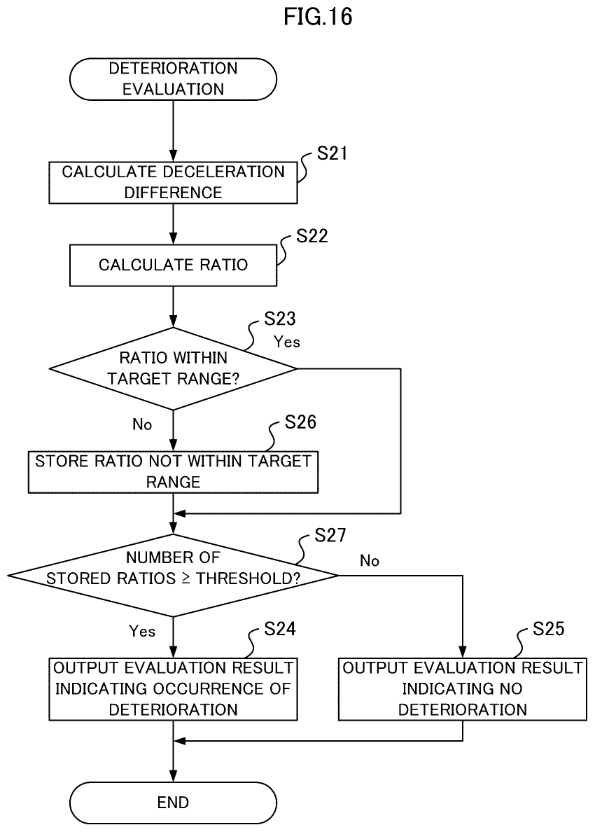

To improve the accuracy of deterioration evaluation, the evaluator 42 may determine whether the ratio is out of the target range multiple times, as illustrated in FIG. 16. The processing in steps S21 to S25 in FIG. 16 is the same as the processing in steps S21 to S25 in FIG. 7 executed by the deterioration evaluating device 41 according to Embodiment 1. When determining that the ratio calculated in step S22 is not within the target range in step S23 (step S23; No), the evaluator 42 causes the ratio and the corresponding date and time to be stored into a storage device, which is not illustrated (step S26). In contrast, when determining that the ratio calculated in step S22 is within the target range (step S23; Yes), the evaluator 42 skips step S26.

The evaluator 42 then determines whether the number of ratios stored in the storage device is at least a threshold (step S27). When determining that the number of ratios stored in the storage device is at least the threshold (step S27; Yes), the evaluator 42 outputs the result of deterioration evaluation indicating occurrence of deterioration of the mechanical brake devices 93, to the brake controller 31 (step S24). In contrast, when determining that the number of ratios stored in the storage device is smaller than the threshold (step S27; No), the evaluator 42 outputs the result of deterioration evaluation indicating no deterioration of the mechanical brake devices 93, to the brake controller 31 (step S25).

The brake control apparatus 21 may stop the process of evaluating a level of deterioration in the case of any abnormality in the brake control, in order to improve the accuracy of evaluation of a level of deterioration of the mechanical brake devices 93. For example, when the period from satisfaction of the initiation condition until stop of the railway vehicle exceeds an allowable range of a predetermined period, for example, a period needed for running from the brake starting position to the station, the determiner 54 of the actual deceleration acquiring device 51 may stop the actual deceleration acquiring process. The deterioration evaluating device 41 in this case does not acquire an actual deceleration and thus does not execute the deterioration evaluating process.

The brake control apparatus 21 may stop the process of evaluating a level of deterioration under anti-skid control, in order to improve the accuracy of evaluation of a level of deterioration of the mechanical brake devices 93. For example, the determiner 54 of the actual deceleration acquiring device 51 may stop the actual deceleration acquiring process in response to sudden drops in the values measured by the speed sensors 94 in the period from satisfaction of the initiation condition until stop of the railway vehicle. The deterioration evaluating device 41 in this case does not acquire an actual deceleration and thus does not execute the deterioration evaluating process.

The brake control apparatus 21 may use the average of actual decelerations to evaluate a level of deterioration of the mechanical brake devices 93, in order to improve the accuracy of evaluation of a level of deterioration of the mechanical brake devices 93. In detail, the evaluator 42 may determine the average of actual decelerations acquired by the actual deceleration acquiring device 51 at different timings for the same target deceleration, and may evaluate a level of deterioration of the mechanical brake devices 93 on the basis of whether the ratio of the difference between the average of actual decelerations and the target deceleration to the target deceleration is within a target range.

The braking force adjuster 34, in the case of a positive ratio acquired from the evaluator 42, may adjust the target braking force by subtracting the product of the target braking force and the absolute value of the ratio from the target braking force. The braking force adjuster 34 may adjust the target braking force by any procedure other than that in the above-described examples, provided that the procedure can compensate for variations in the mechanical braking force caused by deterioration of the mechanical brake devices 93.

The initiation condition for initiating the process of acquiring an actual deceleration executed by the actual deceleration acquiring device 51 in the above-described examples may be replaced with other conditions. For example, the process of acquiring an actual deceleration may be initiated when the railway vehicle arrives at any site.

The subject period may be ended at any timing other than the timing of stop of the railway vehicle. For example, the subject period may be ended when the speed of the railway vehicle reaches a predetermined speed. For another example, the subject period may have a predetermined length. In other words, the subject period may be a period from satisfaction of the initiation condition for initiating the process of acquiring an actual deceleration until elapse of a predetermined duration.

The determiner 54 of the actual deceleration acquiring device 51 may determine an actual deceleration by a procedure other than that in the above-described examples. For example, the determiner 54 may determine an actual deceleration by dividing the difference between the speeds of the railway vehicle at the start and the end of the subject period, by the length of the subject period. In this case, the speed acquirer 53 of the actual deceleration acquiring device 51 acquires a time of every determination of a speed of the railway vehicle in step S13 of FIG. 5, and causes the determined speed of the railway vehicle to be stored in association with the time into the storage device. In the example illustrated in FIG. 6, the determiner 54 may determine an actual deceleration by dividing the difference in speed (−V1) by the period τ1 from the time T1 until the time T2.

The electric braking force is not necessarily generated by regenerative braking and may also be generated by dynamic braking.

Although the above-described embodiments are directed to the regular brake control, the level of deterioration of the mechanical brake devices 93 may also be used in the emergency brake control to adjust the pressure of air to be output from emergency solenoid valves used in the emergency brake control.

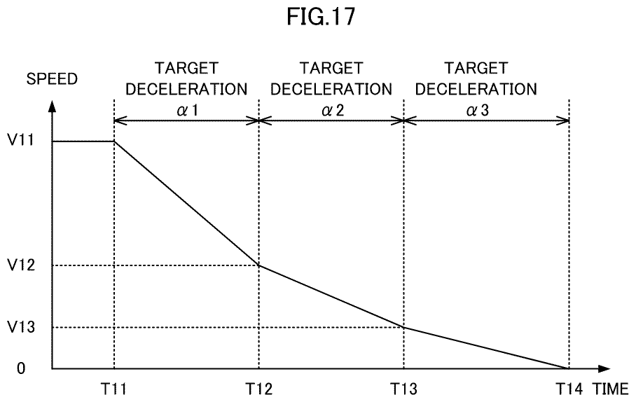

Although the braking command indicates a constant target deceleration in the subject period of the actual deceleration acquiring process in the above-described embodiments, the braking command may change in the subject period. In the case of a change in the target deceleration indicated by the braking command as illustrated in FIG. 17, the evaluator 42 calculates a target deceleration for the subject period from the time T11 until the time T14, on the basis of a target deceleration α1 from the time T11 until the time T12, a target deceleration α2 from the time T12 until the time T13, and a target deceleration α3 from the time T13 until the time T14. The evaluator 42 then evaluates a level of deterioration of the mechanical brake devices 93, from the actual deceleration acquired by the actual deceleration acquiring device 51 and the target deceleration calculated as described above.

The evaluator 42 may output the result of evaluation and the ratio of the difference between the actual deceleration and the target deceleration to the target deceleration, to an integrated train management system. The integrated train management system may analyze signs of deterioration of the mechanical brake devices 93, for example, on the basis of the ratio of the difference between the actual deceleration and the target deceleration to the target deceleration.

The deterioration evaluating device 41 may be a device independent from the brake control apparatus 21. In this case, the result of evaluation by the deterioration evaluating device 41 may be transmitted to the brake control apparatus 21, or transmitted to a display device installed in the cab, or a vehicle control system in a rail yard, for example, without being transmitted to the brake control apparatus 21.

The deterioration evaluating device 41 may be achieved in the form of an in-vehicle device independent from the brake control apparatus 21 and installed in the railway vehicle, or in the form of a function of the integrated train management system.

The switcher 52 may be installed as a function of the ATO device. The switcher 52 may output the deactivation signal S5, in response to a manipulation on a manipulation switch installed in the cab.

The speed acquirer 53 of the actual deceleration acquiring device 51 may calculate a position of the railway vehicle on the basis of the radio waves from a global positioning system (GPS) satellite, and determine a speed of the railway vehicle from an amount of displacement of the railway vehicle per unit time.

The power conversion apparatus 1 may be installed in a railway vehicle of an AC feeding system. In this case, the railway vehicle may be provided with a transformer that reduces the voltage of AC power fed from the current collector and a converter that converts the AC power after voltage reduction by the transformer into DC power. The power conversion apparatus 1 converts the DC power fed from the converter into AC power, and feeds the converted AC power to the motors IM1.

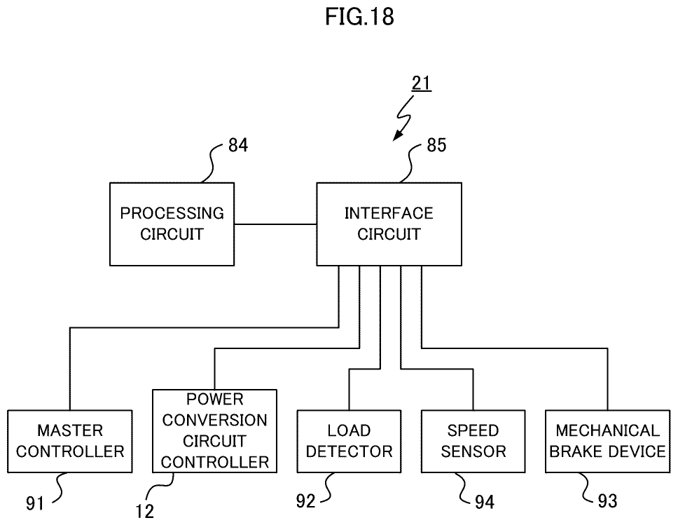

The brake control apparatus 21 may have hardware components other than those in the above-described examples. The brake control apparatus 21 may be achieved by a processing circuit 84, as illustrated in FIG. 18. The processing circuit 84 is connected to the master controller 91, the power conversion circuit controller 12, the load detector 92, the mechanical brake devices 93, and the speed sensors 94, via an interface circuit 85.

In the case where the processing circuit 84 is dedicated hardware, the processing circuit 84 includes a single circuit, a combined circuit, a processor, an application specific integrated circuit (ASIC), a field programmable gate array (FPGA), or a combination thereof, for example. The individual components of the brake control apparatus 21 may be achieved by separate processing circuits 84 or by the same processing circuit 84.

A part of the functions of the brake control apparatus 21 may be achieved by dedicated hardware, whereas another part of the functions may be achieved by software or firmware. For example, the components of the actual deceleration acquiring device 51 may be achieved by the processing circuit 84 illustrated in FIG. 18, whereas the evaluator 42 and the brake controller 31 may be achieved by programs stored in the memory 82 when the programs are read and executed by the processor 81 illustrated in FIG. 4, in the brake control apparatus 21.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Power conversion apparatus
1a, 1b Terminal
11 Power conversion circuit
12 Power conversion circuit controller
21 Brake control apparatus
31 Brake controller
32 Target braking force determiner
33 Regeneration controller
34 Braking force adjuster
35 Mechanical brake controller
41 Deterioration evaluating device
42 Evaluator
51 Actual deceleration acquiring device
52 Switcher
53 Speed acquirer
54 Determiner
55 Deceleration adjuster
80 Bus
81 Processor
82 Memory
83 Interface
84 Processing circuit
85 Interface circuit
91 Master controller
92 Load detector
93 Mechanical brake device
94 Speed sensor
FC1 Filter capacitor
IM1 Motor
S1 Operation command
S2 Power conversion control signal
S3 Regeneration pattern
S4 Regeneration feedback
S5 Deactivation signal

1. An actual deceleration acquiring device, comprising:
speed acquiring circuitry to acquire, for a subject period, a speed of a railway vehicle that is accelerated by a driving force received from a motor rotating in response to fed electric power and is decelerated by at least either of a mechanical braking force or an electric braking force, while the railway vehicle is being decelerated by not the electric braking force but the mechanical braking force alone among the mechanical braking force and the electric braking force, the mechanical braking force being generated by a mechanical brake device, the electric braking force resulting from consumption of electric power output from a power conversion circuit configured to convert electric power fed by the motor serving as an electric generator and output the converted electric power;
determining circuitry to determine, based on a variation in the speed acquired by the speed acquiring circuitry, an actual deceleration of the railway vehicle in the subject period; and
switching circuitry to stop, in response to satisfaction of an initiation condition for initiating a process of acquiring an actual deceleration, power conversion of the power conversion circuit when an operation command of the railway vehicle contains a braking command for instructing the railway vehicle to decelerate, wherein
the speed acquiring circuitry acquires the speed of the railway vehicle for the subject period after the switching circuitry stops the power conversion of the power conversions circuit.

2-3. (canceled)

4. The actual deceleration acquiring device according to claim 1, wherein the switching circuitry stops the power conversion of the power conversion circuit in accordance with a place where the railway vehicle is running.

5. The actual deceleration acquiring device according to claim 1, wherein the speed acquiring circuitry acquires the speed of the railway vehicle for the subject period while the railway vehicle is being decelerated by the mechanical braking force alone in accordance with a target deceleration indicated by ti braking command, the target deceleration being deemed to be constant in the subject period.

6. The actual deceleration acquiring device according to claim 1, wherein the subject period is a period from arrival of the railway vehicle at a predetermined position until stop of the railway vehicle.

7. The actual deceleration acquiring device according to claim 1, further comprising:
deceleration adjusting circuitry to adjust, in accordance with an inclination of a place where the railway vehicle is running in the subject period, the actual deceleration determined by the determining circuitry.

8. A deterioration evaluating device, comprising:
the actual deceleration acquiring device according to claim 1; and
evaluating circuitry
to acquire, from the determining circuitry of the actual deceleration acquiring device, the actual deceleration determined by the determining circuitry, and
to evaluate, based on the acquired actual deceleration, a level of deterioration of the mechanical brake device.

9. A deterioration evaluating device, comprising:
the actual deceleration acquiring device according to claim 7; and
evaluating circuitry
to acquire, from the deceleration adjusting circuitry of the actual deceleration acquiring device, the actual deceleration adjusted by the deceleration adjusting circuitry, and
to evaluate, based on the acquired actual deceleration, a level of deterioration of the mechanical brake device.

10. The deterioration evaluating device according to claim 8, wherein the evaluating circuitry evaluates, based on a comparison between the acquired actual deceleration and a target deceleration, the level of deterioration of the mechanical brake device, the target deceleration being indicated by the braking command.

11. The deterioration evaluating device according to claim 10, wherein the evaluating circuitry evaluates, based on whether a ratio of a difference between the acquired actual deceleration and the target deceleration to the target deceleration is within a target range, the level of deterioration of the mechanical brake device.

12. The deterioration evaluating device according to claim 8, wherein the evaluating circuitry
determines an average of acquired actual decelerations, and
evaluates, based on whether a ratio of a difference between the average and a target deceleration to the target deceleration is within a target range, the level of deterioration of the mechanical brake device, the target deceleration being indicated by the braking command.

13. deterioration evaluating device, comprising:
speed acquiring circuitry to acquire, for a subject period, a speed of a railway vehicle that is accelerated by a driving force received from a motor rotating in response to fed electric power and is decelerated by at least either of a mechanical braking force or an electric braking force, while the railway vehicle ius being decelerated by not the electric braking force but the mechanical braking force alone among the mechanical braking force and the electric braking force, the mechanical braking force being generated by a mechanical brake device, the electric braking force resulting from consumption of electric power generated by the motor serving as an electric generator;
determining circuitry to determine, based on a variation in the speed acquired by the speed acquiring circuitry, an actual deceleration of the railway vehicle in the subject period; and
evaluating circuitry to evaluate, based on the actual deceleration determined by the determining circuitry, a level of deterioration of the mechanical brake device, wherein the evaluating circuitry
acquires another actual deceleration of another railway vehicle determined by the determining circuitry of another actual deceleration acquiring device configured to determine an actual deceleration of the other railway vehicle, and
evaluates, based on a comparison between the actual deceleration of the railway vehicle acquired from the determining circuitry and the other actual deceleration of the other railway vehicle acquired from the determining circuitry of the other actual deceleration acquiring device, the level of deterioration of the mechanical brake device.

14. A brake control apparatus, comprising:
the deterioration evaluating device according to claim 8; and
brake controlling circuitry to control the mechanical brake device and a power conversion circuit controlling circuitry in accordance with a target deceleration indicated by the braking command and in accordance with a result of evaluation by the deterioration evaluating device, the power conversion circuit controlling circuitry being configured to control the power conversion circuit.

15. A brake control apparatus, comprising:
the deterioration evaluating device according to claim 8;
brake controlling circuitry to control the mechanical brake device and power conversion circuit controlling circuitry in accordance with a target deceleration indicated by the braking command and in accordance with a result of evaluation by the deterioration evaluating device, the power conversion circuit controlling circuitry being configured to control the power conversion circuit;
target braking force determining circuitry to determine a target braking force in accordance with the target deceleration;
braking force adjusting circuitry to adjust the target braking force in accordance with the result of evaluation by the deterioration evaluating device;
a regeneration controlling circuitry
to determine a target electric braking force in accordance with the target braking force adjusted by the braking force adjusting circuitry, and
to output a regeneration pattern indicating the target electric braking force to the power conversion circuit controlling circuitry; and
mechanical brake controlling circuitry
to acquire a regeneration feedback indicating an actual electric braking force from the power conversion circuit controlling circuitry,
to determine a target mechanical braking force, based on the target braking force adjusted by the braking force adjusting circuitry and the actual electric braking force, and
to control the mechanical brake device in accordance with the target mechanical braking force.

16. A brake control apparatus, comprising:
the deterioration evaluating device according to claim 8;
brake controlling circuitry to control the mechanical brake device and power conversion circuit controlling circuitry in accordance with a target deceleration indicated by the braking command and in accordance with a result of evaluation by the deterioration evaluating device, the power conversion circuit controlling circuitry being configured to control the power conversion circuit;
target braking force determining circuitry to determine a target braking force in accordance with the target deceleration;
regeneration controlling circuitry
to determine a target electric braking force in accordance with the target braking force, and
to output a regeneration pattern indicating the target electric braking force to the power conversion circuit controlling circuitry;
braking force adjusting circuitry to adjust the target braking force in accordance with the result of evaluation by the deterioration evaluating device; and
mechanical brake controlling circuitry
to acquire a regeneration feedback indicating an actual electric braking force from the power conversion circuit controlling circuitry,
to determine a target mechanical braking force, based on the target braking force adjusted by the braking force adjusting circuitry and the actual electric braking force, when the actual electric braking force is smaller than the target braking force determined by the target braking force determining circuitry, and
to control the mechanical brake device in accordance with the target mechanical braking force.

17. A method comprising:
acquiring, for a subject period, a speed of a railway vehicle that is accelerated by a driving force received from a motor rotating in response to fed electric power and is decelerated by at least either of a mechanical braking force or an electric braking force, while the railway vehicle is being decelerated by not the electric braking force but the mechanical braking force alone among the mechanical braking force and the electric braking force, the mechanical braking force being generated by a mechanical brake device, the electric braking force resulting from consumption of electric power output from a power conversion circuit configured to convert electric power fed by the motor serving as an electric generator and output the converted electric power;
determining, based on a variation in the acquired speed, an actual deceleration of the railway vehicle in the subject period; and
stopping, in response to satisfaction of an initiation condition for initiating a process of acquiring an actual deceleration, power conversion of the power conversion circuit when an operation command of the railway vehicle contains a braking command for instructing the railway vehicle to decelerate, wherein
the speed of the railway vehicle for the subject period is acquired after stopping the power conversion of the power conversion circuit.

18. The method according to claim 17 further comprising:
evaluating, based on the determined actual deceleration, a level of deterioration of the mechanical brake device.

19. The method according to claim 18, further comprising:
controlling, in accordance with a target deceleration and the evaluated level of deterioration of the mechanical brake device, the mechanical brake device and the power conversion circuit, the target deceleration being indicated by the braking command.
